(19) United States
(12) Patent Application Publication
(10) Pub. No.: US 2012/0061212 A1
(43) Pub. Date: Mar. 15, 2012

(54) PIPE CONVEYORS

(76) Inventors: Christof Brewka, Highlands Ranch, CO (US); Ingolf W. Neubecker, Rye, CO (US)

(21) Appl. No.: 13/236,482

(22) Filed: Sep. 19, 2011

Related U.S. Application Data
(63) Continuation-in-part of application No. 12/120,709, filed on May 15, 2008, now Pat. No. 8,033,385.
Application No. 12/120,709 is a continuation of application No. 13/050,790, filed on Mar. 17, 2011.
(60) Provisional application No. 60/938,095, filed on May 15, 2007.
(60) Provisional application No. 61/314,812, filed on Mar. 17, 2010.

(51) Int. Cl. B65G 15/08; B65G 15/56

(52) U.S. Cl. 198/819; 198/844.1

(57) ABSTRACT

A conveyor system may include a pipe conveyor with a head end, a tail end, and an inclined section. The conveyor system may also include a conveyor belt comprising a first portion and a second portion, and the conveyor belt may be configured to form a pipe shape when the first and second portions of the conveyor belt are overlapped. In some embodiments, the first portion may include a first type of longitudinal reinforcement elements and the second portion may not include any of the first type of longitudinal reinforcement elements. In some embodiments, the conveyor system may include a material plug configured to circumferentially engage at least a portion of an internal surface of the conveyor belt.

### CROSS-REFERENCE TO RELATED APPLICATIONS

This application is a continuation-in-part of U.S. non-provisional application Ser. No. 12/120,709 filed on May 15, 2008 which claims priority to U.S. provisional application 60/938,095 filed on May 15, 2007; and also a continuation-in-part of U.S. non-provisional application Ser. No. 13/050,790 filed on Mar. 17, 2011 which claims priority to U.S. provisional application No. 61/314,812 filed on Mar. 17, 2010, all of which are incorporated by reference herein in their entirety.

### FIELD OF INVENTION

The present invention generally relates to pipe conveyors, and more particularly to steep angle pipe conveyor systems and vertical pipe conveyor systems.

### BACKGROUND

One type of conveyor for transporting material is a pipe conveyor, which can be used to protect the material being transported by enclosing it. As such, pipe conveyors are often used in situations where spillage or dust may be an issue or where use of conventional conveyor systems may be too costly or hazardous due to environmental or population concerns. Pipe conveyers may be useful, for example, to convey bulk material between the phases of mining, processing, and storage. Pipe conveyors are also useful in situations in which the conveyor layout requires horizontal and/or vertical curves, especially, when the conveyor layout includes a vertical rise or fall. Conventional pipe conveyors, however, are generally limited to being used in conveyor systems with vertical angles of less than 30 degrees as measured from a horizontal axis. While some pipe conveyor designs exist that allow for pipe conveyors to rise at vertical angles greater than 30 degrees, these systems are often limited to relatively short total elevation differentials, thus limiting their ability to be used in conveyor systems with large vertical elevation gains.

Some pipe conveyors transport material in a circular cross-section formed by overlapping belt edges and using idlers arranged in a hexagonal pattern to form the tubular pipe-like shape. At the loading point these systems provide a trough or flat conveyor for loading of the material. After loading the material, the belt is formed into a pipe shape for the transport length of the system and re-opened at the destination for the unloading of the material in the standard manner of a troughed or flat conveyor. Because the material is enclosed by the belt during transport, spillage, scattering, pollution, and flying dust may be reduced. These systems also may allow the pipe conveyor to maneuver both vertical and horizontal curves that would be difficult for conventional conveyors to pass through. Also, because pipe conveyors can load and discharge the bulk material in the conventional manner, standard equipment may be used at the head and tail ends.

### SUMMARY OF THE INVENTION

One embodiment of a conveyor system may include a pipe conveyor with a head end, a tail end positioned at an elevation lower than the head end, and an inclined section between the head end and the tail end. The conveyor system may also include a conveyor belt with a first portion and a second portion, the first portion having a first type of longitudinal reinforcement elements and the second portion not having any of the first type of longitudinal reinforcement elements.

Another embodiment of a conveyor system may include a pipe conveyor with a head end, a tail end positioned at an elevation lower than the head end, and an inclined section between the head end and the tail end. The conveyor system may also include a conveyor belt with a first portion and a second portion, the conveyor belt configured to form a pipe shape when the first and second portions of the conveyor belt are overlapped. The conveyor system may also include a material plug configured to circumferentially engage at least a portion of an internal surface of the conveyor belt when the conveyor belt is formed in the pipe shape and help prevent backflow of a material transported in the pipe shape of the conveyor belt.

An embodiment of a conveyor belt may include a middle portion, a first side portion coupled to the middle portion, and a second side portion also coupled to the middle portion. The middle portion may comprising a first type of longitudinal reinforcement elements extending along a length of the conveyor belt, and the first and second side portions may be more flexible than the middle portion. The conveyor belt may also include a first flap coupled to the first side portion and a second flap coupled to the second side portion. The first and second flaps may be configured to overlap when the conveyor belt is formed into a pipe shape to transport a column of material.

### BRIEF DESCRIPTION OF THE DRAWINGS

FIG. 1 shows a schematic side elevation view of a vertical pipe conveyor system.

FIG. 2 shows a schematic cross-section of the vertical pipe conveyor system of FIG. 1, viewed along line 2-2 in FIG. 1.

FIG. 3 shows a schematic cross-section of the vertical pipe conveyor system of FIG. 1, viewed along line 3-3 in FIG. 1.

FIG. 4 shows a schematic cross-section of the vertical pipe conveyor system of FIG. 1, viewed along line 4-4 in FIG. 1.

FIG. 5 shows a schematic side elevation view of a second version of a vertical pipe conveyor system.

FIG. 6 shows a schematic cross-section of the vertical pipe conveyor system of FIG. 5, view along line 6-6 in FIG. 5.

FIG. 7A shows a perspective view of a lower portion of a steep angle pipe conveyor system.

FIG. 7B shows another perspective view of the lower portion of the steep angle pipe conveyor system of FIG. 7A.

FIG. 8A shows a perspective view of an upper portion of a steep angle pipe conveyor system.

FIG. 8B shows another perspective view of the upper portion of the steep angle pipe conveyor system of FIG. 8A.

FIG. 9 shows a schematic cross-section of a support element of the steep angle pipe conveyor system of FIGS. 7A through 8B.

FIG. 10 shows a schematic side elevation view of a support element of the steep angle pipe conveyor system of FIGS. 7A through 8B.

FIG. 11A shows a schematic cross-section of a pipe conveyor belt for use in a vertical pipe conveyor system or a steep angle pipe conveyor system.

FIG. 11B shows a schematic cross-section of a pipe conveyor belt for use in a vertical pipe conveyor system or a steep angle pipe conveyor system.

FIG. 12A shows a schematic cross-section of a pipe conveyor belt with a material plug for use in a vertical pipe conveyor system or a steep angle pipe conveyor system.

FIG. 12B shows a schematic cross-section of a pipe conveyor belt with two material plugs for use in a vertical pipe conveyor system or a steep angle pipe conveyor system.

FIG. 12C shows a schematic cross-section of a pipe conveyor belt with a material plug secured to a belt with a mounting structure for use in a vertical pipe conveyor system or a steep angle pipe conveyor system.

### DETAILED DESCRIPTION

Described herein are vertical and steep angle pipe conveyor systems that may be used to transport materials from one location to another location. Pipe conveyors systems may be suited for use in, for example, mines that include steep or vertical angles that are greater than thirty degrees as measured from a horizontal plane. These pipe conveyors may include a belt that is formed into a pipe-like shape to define a space that contains the material to be transported by the conveyor. The belt may include reinforcement elements within the belt or coupled to the belt. The reinforcement elements may be located in certain portions of the belt, such as in a lower portion, in order to allow side portions of the belt to be more flexible. The belt may also include multiple types of reinforcement elements, which may also be preferentially located in certain portions of the belt. Vertical and steep angle pipe conveyor systems may also include one or more material plugs that help prevent material being transported from falling back down into a mine.

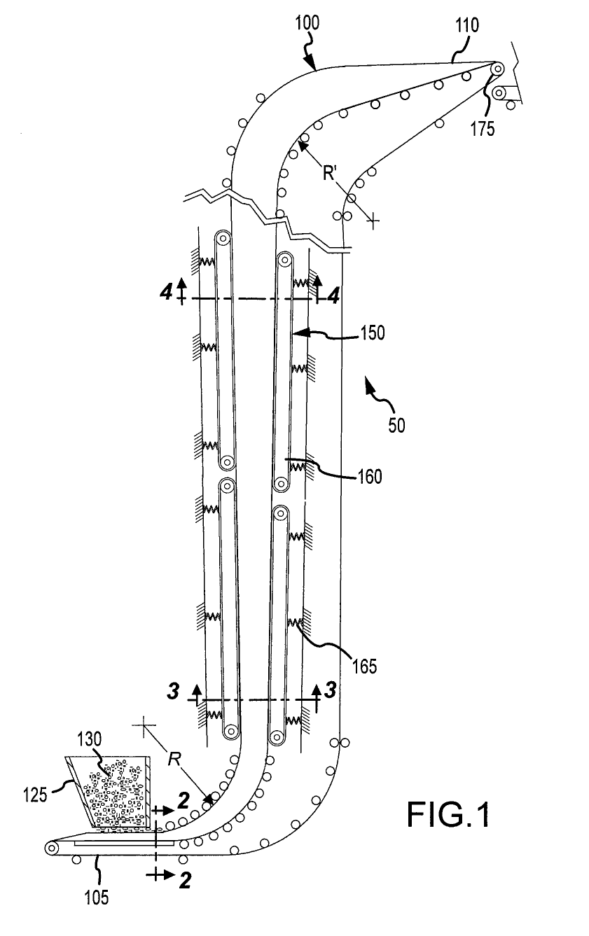

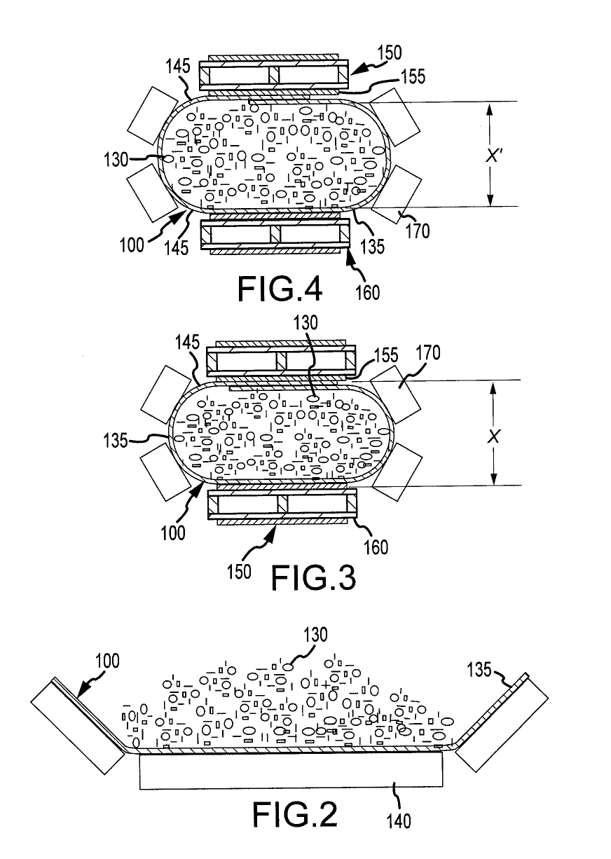

FIG. 1 shows a schematic of a vertical pipe conveyor system. FIGS. 2-4 show schematic cross-section views of the vertical pipe conveyor system at various locations. With reference to FIG. 1, the vertical pipe conveyor system 50 may include a pipe conveyor 100. The pipe conveyor 100 may include a tail end 105 and a head end 110. The head end 110 of the pipe conveyor 100 may be positioned at a higher elevation than the tail end 105. Starting from the tail end 105 of the pipe conveyor 100, the pipe conveyor 100 may include a first substantially horizontal, or sloped (up to, for example, 15°), section that transitions to an inclined section. The inclined section may be substantially vertical, as shown in FIG. 1, or any other desired incline from a substantially horizontal plane. Proximate the head end 105 of the pipe conveyor 100, the inclined section of the pipe conveyor may transition to a second substantially horizontal, or sloped (up to, for example, 15°), section.

A material loader 125 may be positioned proximate the tail end 105 of the pipe conveyor 100. The material loader 125 deposits material 130 onto a belt 135 of the pipe conveyor 100 for transport from the tail end 105 to the head end 110 of the pipe conveyor 105. With reference to FIG. 2, the belt 135 of the pipe conveyor 100 may be formed into a trough or channel shape (or in some embodiments, a flat shape) in the area where the pipe conveyor 100 receives material 130 from the material loader 125, and a slider bed 140 may be positioned under the belt 135 to provide support for the belt 135 as material 130 is placed onto it. After the material 130 is deposited onto the belt 135, the belt 135 may be formed into a pipe shape by overlapping the ends of the belt 135, as shown for example in FIGS. 3 and 4. The belt 135 is formed into this pipe shape prior to transitioning into the inclined section and maintained in this pipe shape through the inclined section. After the belt transitions from the inclined section to the second horizontal section, the belt 135 may return to its trough shape configuration, or to a flat configuration, so that the material 130 loaded onto the pipe conveyor 100 may be discharged from the pipe conveyor 100 at the head end 110 of the pipe conveyor 100. Any suitable structure system for changing the form of the belt from its trough shaped configuration to its pipe shaped configuration, and vice versa, may be utilized.

With reference to FIGS. 3 and 4, the belt 135 may define an oval cross-section (as viewed along the length of the belt 135) that contains material 130 when formed into the pipe shape. This oval cross-section area may be designed for at least 95% of the cross-sectional area to be filled with material 130 transported by the pipe conveyor 100. Use of an oval cross-section may provide two substantially flat surfaces on the two substantially linear sides 145 for engagement with friction drive conveyors 150, as described in more detail below. Further, the oval cross-section facilitates designing a pipe conveyor 100 that defines a sufficient area for receiving material 130 to be transported by the pipe conveyor 100 while allowing for smaller radii to be used when transitioning from the horizontal to the incline sections.

Specifically, when designing a pipe conveyor 100 where the belt 135 is formed to define an oval cross-section area, the distance between the parallel substantially linear sides 145 of the belt 135, which distance is identified as X and X′ in FIGS. 3 and 4 respectively, will typically be a function of the desired radii for the transitions between the incline section and the first and second horizontal sections, which are identified as R and R′, respectively, in FIG. 1, and the required transport volume, which is typically expressed as volume per unit time. Generally, the distances X and X′ should be kept small because as the distances X and X′ decrease, smaller radii for the transitions R and R′ can be used for a given belt stiffness. Smaller radii R and R′, in turn, allow for shorter transitions between horizontal and inclined sections of the pipe conveyor 100, which can be useful when space constraints require short transitions between horizontal and inclined sections of the pipe conveyor 100. While it is generally desirable to have small distances X and X′, the distances need to nonetheless be large enough to define a sufficient oval cross-section area for transporting material 130 from the tail end 105 to the head end 110 of the pipe conveyor 100 at the required transport volume.

With continued reference to FIGS. 1, 3 and 4, the cross-section area defined by the belt 135 may taper outward along the inclined section from the first horizontal section to the second horizontal section. The taper may be approximately 50 mm for every 10,000 mm of belt length, although in other embodiments the taper may be different. As the cross-section tapers outward, the overlap of the ends of the belt 135 slightly decreases and the distance between the parallel substantially linear sides 145 of the belt increases slightly (i.e., distance X′ is slightly more than distance X). This decrease in overlap and increase in distance between the parallel sides is shown schematically in FIGS. 3 and 4. The result of these changes is that the cross-section area defined by the belt 135, within the inclined section, increases from the first horizontal section to the second horizontal section. Increasing the cross-section area defined by the belt 135 by tapering it outward from the first horizontal section to the second horizontal section helps reduce the tendency for material 130 to slide down the inclined section towards the first horizontal section. Tapering the belt 135 outward also helps to press the belt 135 against the one or more friction drive conveyors 150 that are placed along the inclined section of the pipe conveyor 100.

Returning to FIG. 1, one or more friction drive conveyors 150 may be positioned proximate the pipe conveyor 100 along the inclined section of the pipe conveyor 100. Each friction drive conveyor 150 may include a friction drive belt 155 and a support structure 160. The support structure 160 provides support for the friction drive belt 155. Each friction drive conveyor 150 may be positioned relative to the pipe conveyor 100 such that its respective friction drive belt 155 engages the substantially linear sides 145 of the belt 135 of the pipe conveyor 100. This engagement of the friction drive conveyors 150 with the pipe conveyor 100 results in the friction drive conveyors 150 applying pushing forces to the pipe conveyor 100. These forces help push the belt 135, and any material 130 contained therein, from the first horizontal section to the second horizontal section.

The magnitude of the forces applied by a friction drive conveyor 150 for pushing the belt 135 may be controlled using one or more bias members 165, such as springs. More particularly, one or more bias members 165, such as springs, may be joined to the support structure 160 of the friction drive conveyor 150. These bias members 165 may be configured to apply a force to the support structure 160 that results in the friction drive belt 155 being pressed against the belt 135. As this force increases, the pushing force that can be applied to the pipe conveyor 100 increases since the friction forces applied to the belt 135 by the friction drive belt 155 in a direction parallel to the longitudinal axis of the belt 135 increases. In some embodiments, the bias member 165 may be omitted as the normal force generated between the belt 135 and the friction drive belt 155 may be sufficient from just the outward tapering of the belt 135.

With reference to FIGS. 3 and 4, the friction drive conveyors 150 may be positioned relative to the pipe conveyor 100 such that the friction drive belts 155 of the friction drive conveyors 150 engage the substantially linear sides 145 of the belt 135. Such positioning may increase the contact surface area between the friction drive belts 155 and the relatively flat surfaces of the substantially linear sides 145 of the belt 135. One or more of the friction drive conveyors 150 may be driven, with the individual friction drive conveyors being collectively or individually driven by any type of drive mechanism such as a motor (which may be gas, diesel, electric, etc.). For example, one or more friction drive conveyor 150 may be driven by a shaft mounted variable speed electric motor reducer (not shown).

Rollers 170 (e.g. idler rollers) may be positioned proximate the belt 135 at spaced locations along the inclined section of the pipe conveyor 100 in addition to the friction drive conveyors 150. The rollers 170 may engage the belt 135 to help maintain the oval cross-section shape of the belt 135. In some embodiments, the rollers 170 may engage the curved portions of the oval cross-section of the belt 135 to press the belt 135 inward in order to oppose the outward pressure imposed on the belt 135 by the material 130 contained in the oval cross-section area defined by the belt 135. In other embodiments, as explained below, the rollers 170 may engage the substantially linear sides 145 of the belt 135. Rollers 170 positioned proximate the belt may be mounted on a support structure, such as a support frame. The rollers 170 may be coupled to the support frame via a biasing member, such as a spring, or may be coupled to the support frame without a biasing member.

As shown in FIGS. 3 and 4, a friction drive conveyor 150 may be positioned on each substantially linear side 145 of the belt 135. In some embodiments, however, friction drive conveyors 150 may be positioned on only one of the substantially linear sides 145 of the belt 135. In these embodiments, one or more rollers 170 may be positioned to engage the other substantially linear side of the belt 135 in order to oppose the normal forces applied to the pipe conveyor 100 by the friction drive conveyors 150. The one or more rollers 170 positioned to engage the other substantially linear side may be the same as the rollers 170 positioned to engage the curved portions of the oval cross-section of the belt 134, or may be different types of rollers 170.

As illustrated in FIGS. 3 and 4, for a given cross-section location of the belt 135, some embodiments of the pipe conveyor 100 may include support frames with rollers 170 mounted thereon along portions of the belt 135 that engage one or more friction drive conveyors 150. In other embodiments of the pipe conveyor 100, support frames with rollers 170 may be provided along portions of the belt 135 that do not engage a friction drive conveyor 150. Generally, a pipe conveyor 100 may have portions with a friction drive conveyor 150 but not a support frame, portions with a support frame but not a friction drive conveyor, portions with both a friction drive conveyor 150 and a support frame, and/or portions with neither a friction drive conveyor 150 nor a support frame.

Returning to FIG. 1, a drive pulley 175 may be positioned at the head end 110 of the pipe conveyor 100. The drive pulley 175, in conjunction with the friction drive conveyors 150, lifts the belt 135, and material 130 contained therein, from the first horizontal section to the second horizontal section. Because the friction drive conveyors 150 assist the drive pulley 175 in lifting the belt 135, the drive pulley 175 requires less power than would otherwise be required. Further, because less power is required for the drive pulley 175, the tension imposed on the belt 135 by the drive pulley 175 is less than would otherwise be imposed. This allows for belts with lower modulus of elasticity and/or lower strength to be used for the belt 135.

As the modulus of elasticity for the belt 135 decreases, smaller radii R and R′ can be used in the transition sections of the pipe conveyor 100. Moreover, by positioning a suitable number of friction drive conveyors 150 along the length of the inclined section of the pipe conveyor 100 and appropriately biasing these conveyors 150 against the pipe conveyor 100, the power required for drive pulley 175 to lift the belt 135 can be kept to a minimum regardless of the amount of total vertical distance from the first horizontal section to the second horizontal section, thus allowing the modulus of elasticity of the belt 135 to be kept low enough to permit the pipe conveyor 100 to be used for vertical lift distances and/or inclines that would not be possible with conventional pipe conveyors. Moreover, in some embodiments, the required modulus of elasticity may be sufficiently low enough that fabric belts that do not include any reinforcement elements may be utilized. In other embodiments, as described in more detail below, the belt 135 may include steel or other types of reinforcement elements.

In operation, material 130 is deposited on the pipe conveyor 100 from the material loader 125 at the tail end 105 of the pipe conveyor 100. After depositing the material 130 onto the pipe conveyor 100, the ends of the belt 135 are overlapped to define an oval cross-section area that contains the material 130. After the ends of the belt 135 are overlapped, the pipe conveyor 100 passes through a transition section that changes the direction of travel of the pipe conveyor 100 from substantially horizontal to either vertical or a combination of vertical and horizontal (i.e., inclined). Friction drive conveyors 150 push the pipe conveyor 100, and the material 130 contained therein, upward towards a second transition area were the pipe conveyor 100 transitions from traveling in a vertical or inclined direction back to a substantially horizontal direction of travel.

As the pipe conveyor 100 nears the second transition area, the drive pulley 175 pulls the belt 135 of the pipe conveyor 100 through the final vertical distance until the pipe conveyor 100 is again traveling in a substantially horizontal direction. After the pipe conveyor 100 completes the transition from a vertical or inclined direction of travel to a horizontal direction of travel, the oval cross-section is changed to a trough or flat configuration by undoing the overlap of the ends of the belt 135. Material 130 is then removed from the belt 135 and the belt 135 returns to the tail end 105 of the pipe conveyor 100. In some embodiments, the belt 135 may also transport material 130 from the head end 110 to the tail end 105 of the pipe conveyor 100 as it returns to the tail end 105 of the pipe conveyor 100. In such embodiments, the belt 135 may be configured to define an oval or other cross-section for containing material 130 transported from the head end 110 to the tail end 105 of the pipe conveyor 100.

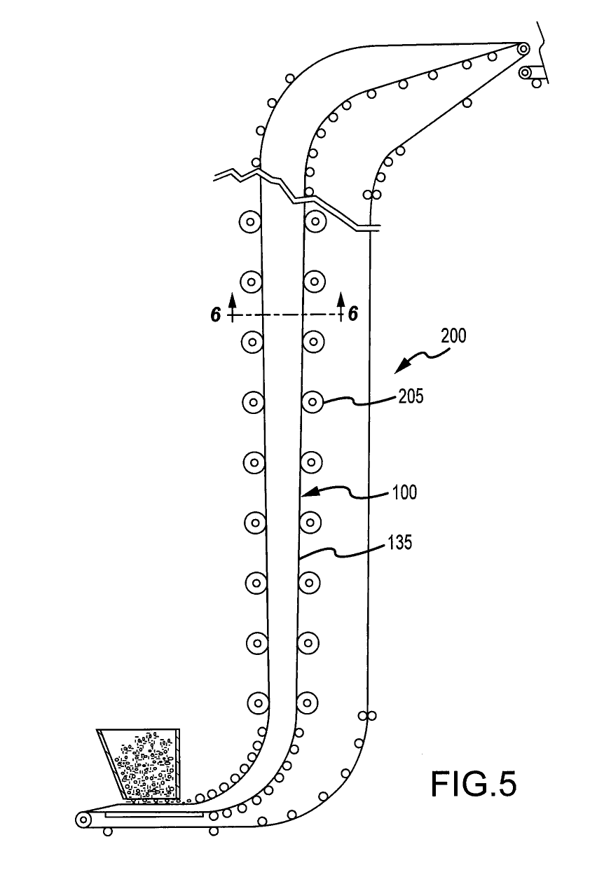

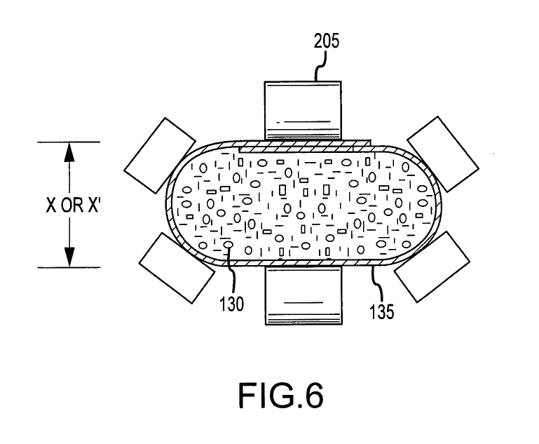

FIG. 5 shows a schematic elevation view of a second version of a vertical pipe conveyor system 200, and FIG. 6 shows a schematic cross-section view of the vertical pipe conveyor system of FIG. 5. The second vertical pipe conveyor system 200 is similar to the first vertical pipe conveyor system 50 and operates in a similar manner except one or more of the friction drive conveyors 150 may be replaced by friction tires 205 or the like. The friction tires 205 serve a purpose similar to the friction drive conveyors 150. In particular, the friction tires 205 help to lift the pipe conveyor 100 while also helping to maintain the shape of the conveyor 100. In general, any combination of friction drive conveyors 150 and/or friction tires 205 may be used in a vertical pipe conveyor system 50, 200.

The friction tires 205 may be installed in pairs on opposite sides of the belt 135. Each friction tire 205 may be configured to engage a substantially flat or linear side of the oval-shaped belt 135 and may in some but not all embodiments be driven. One or more of the friction tires 205 may be generally be driven either individually or collectively (if more than one is driven) by any type of drive mechanism such as a motor (which may be gas, diesel, electric, etc.). For example, one or more friction tires 205 may be driven by a shaft mounted variable speed electric motor reducer (not shown). Each pair of friction tires 205 may be positioned along the length of the belt 135 at a predetermined spacing relative to other pairs of friction tires 205. This spacing may be a function of the total amount of lift friction forces required divided by the installed drive power per pair of friction tires 205.

Each friction tire 205 may be filled with an air pressure that may be selectively adjusted to change the spring-like force applied by the friction tire 205 to the belt 135, and each friction tire 205 may have a different air pressure than the other friction tires 205. The air pressure may be set based upon one or more factors, including, but not limited to, the material properties of the material 130 carried by the pipe conveyor 100, the lifting height between adjacent sets of friction tires 205, or the vertical location of the friction tire 205. Generally, the air pressure may be set within a range that allows the friction tire 205 to flatten the engaged surface of the belt 135 and/or to provide sufficient contact force between the belt 135 and the friction tire 205 while minimizing an amount that the cross-section shape of the belt 135 is indented by the friction tire 205. In some embodiments, the air pressure range may be relatively low (approximately 15 pounds per square inch (“p.s.i.”) to approximately 20 p.s.i.). In other embodiments, the air pressure may be less than 15 p.s.i. or greater than 20 p.s.i.

For reasons of economy and mechanical advantage, each friction tire 205 may have a diameter that is kept as small as possible while also providing a sufficiently firm contact pressure that keeps the cross-sectional area of the belt 135 from expanding under the load of material 130 contained within the belt 135. In some embodiments, the ratio of the tire diameter to the distance X (or X′) defined by the belt 135 may be approximately 1.2:1. The foregoing example is merely illustrative of one possible size for the tire diameter and is not intended to require or imply that the tire diameter must be sized at this ratio relative to the size of the belt 135.

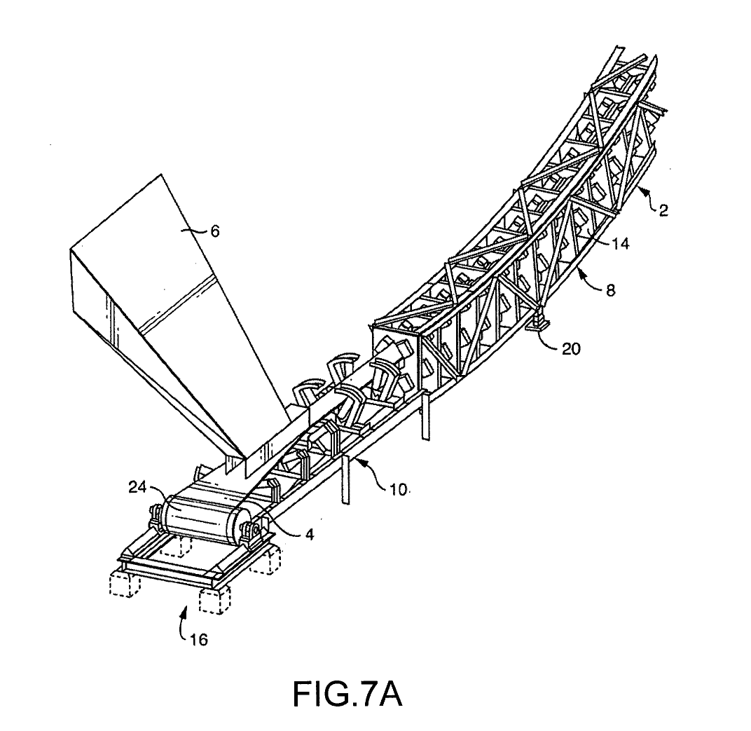

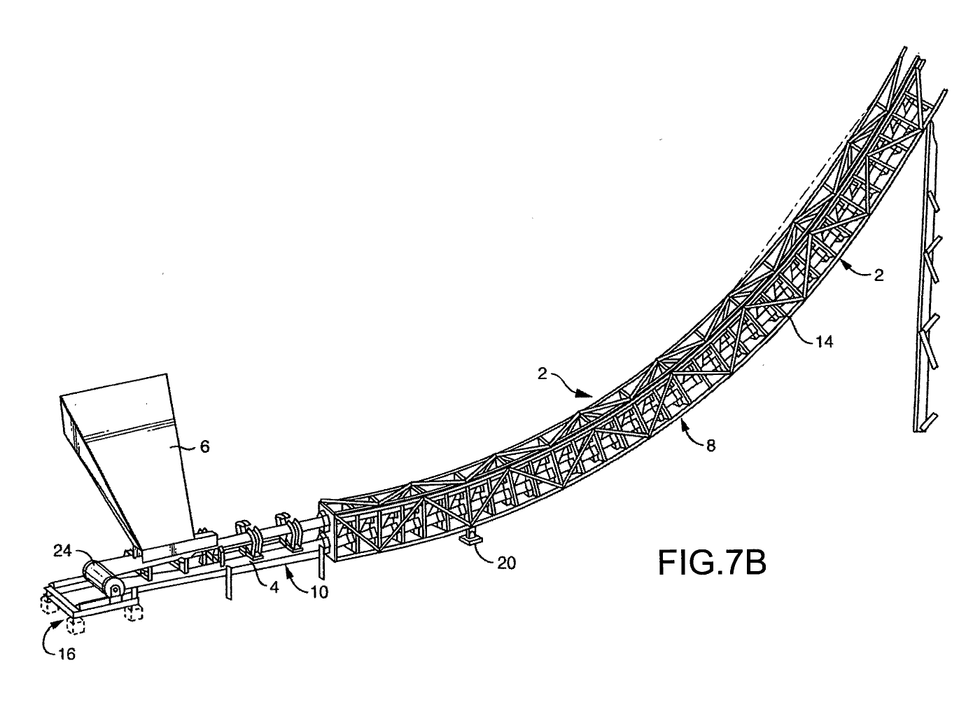

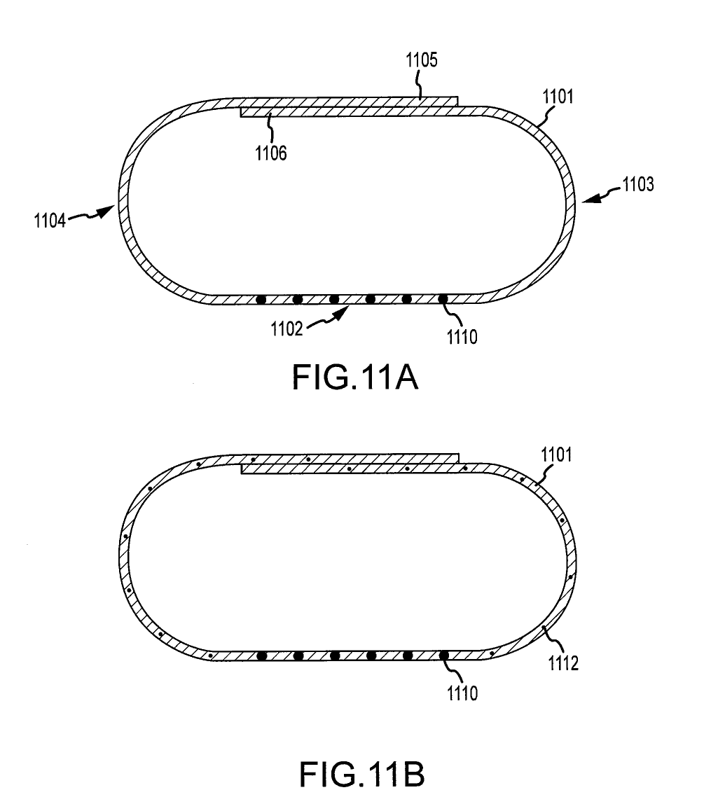

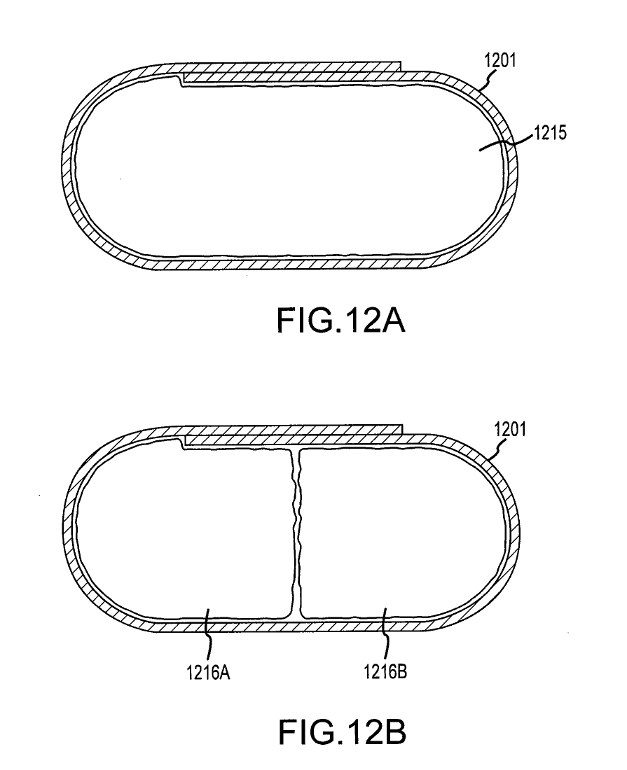

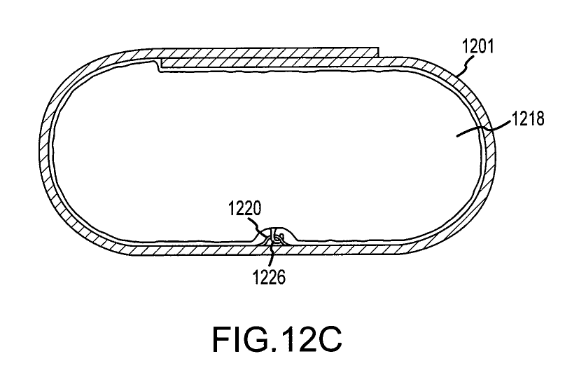

FIGS. 7A through 10 show a steep angle pipe conveyor system. The steep angle pipe conveyor system shown in FIGS. 7A through 10 may be in some ways similar to the vertical pipe conveyor system shown in FIGS. 1 through 6. For example, both the vertical pipe conveyor system and the steep angle pipe conveyor system may transfer material from one location to another in a conveyor belt folded to form a cylindrical or pipe shape. A vertical pipe conveyor system and a steep angle pipe conveyor system may also share many other similarities, such as the use of support elements with rollers, friction drive conveyors, belts with reinforcement elements, material plugs, self-biasing intermediate drive wheels, and so forth. In general, much of the disclosure above regarding the vertical pipe conveyor system in FIGS. 1 through 6 apply also to the steep angle pipe conveyor system in FIGS. 7A through 10, and vice versa. Furthermore, the teachings regarding the vertical pipe conveyor system in FIGS. 1 through 6 and the teachings regarding the steep angle pipe conveyor system in FIGS. 7A through 10 may apply to other conveyor systems as well. Also, as explained in more detail below, the features described in connection with FIGS. 11 through 12 may generally be applied to a vertical pipe conveyor system, a steep angle pipe conveyor system, or any other pipe conveyor or other conveyor system.

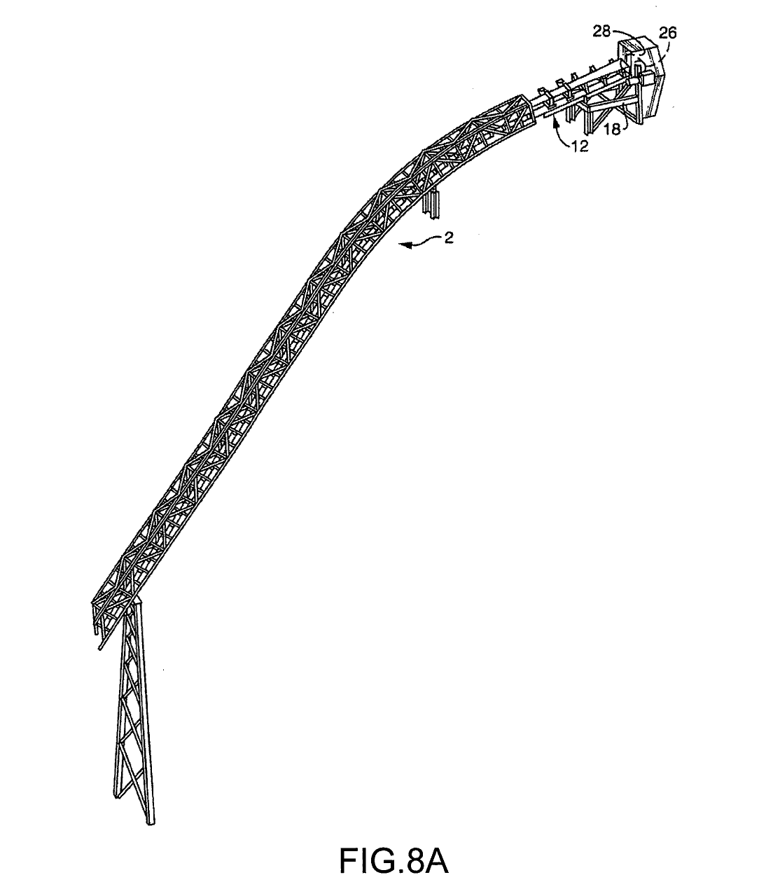

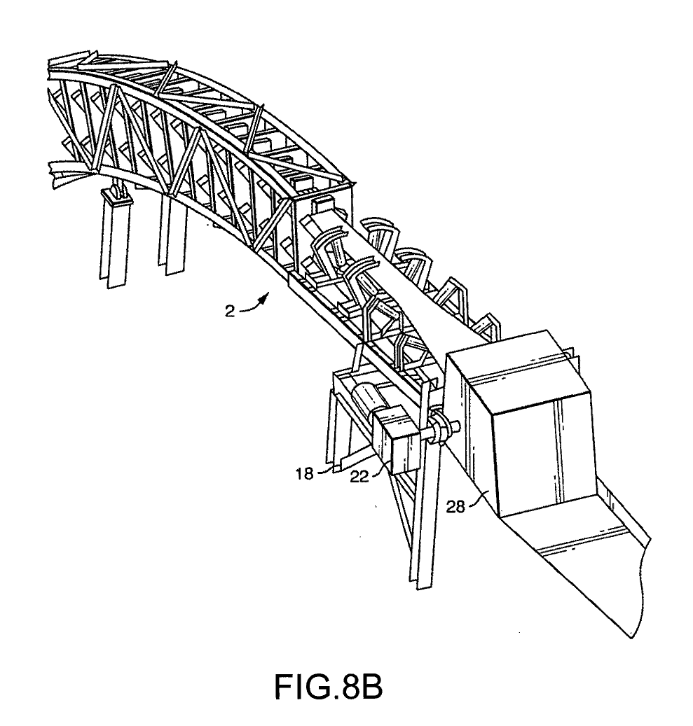

FIG. 7A and FIG. 7B show perspective views of a lower portion of a steep angle pipe conveyor system 2, and FIGS. 8A and 8B show perspective views of an upper portion of the steep angle pipe conveyor system 2 of FIGS. 7A and 7B. The steep angle pipe conveyor system 2 may include a belt 4, similar to the vertical pipe conveyor system 50, 200 in FIGS. 1 through 6. The belt 4 may include a first belt section 40 and a second belt section 42. As with the vertical pipe conveyor system 50, material may be loaded on to the belt 4 via a material loader 6 (e.g. a chute) when the first belt section 40 and the second belt section 42 define an opening. The belt 4 may subsequently be formed into a cylindrical structure 46 by overlapping the first belt section 40 with the second belt section 42 while, for example, the material is transported up the steep angle pipe conveyor system 2. As above, in some embodiments, the material loader may deposit enough material on the belt 4 such that the cross-section of the cylindrical structure 46 is approximately 95% to 100% full. In this manner, the material may be compacted in some embodiments, and the belt 4 may become rigid and stiff in order to hold the material in place as the cylindrical structure 46 of the belt 4 passes through the various supporting elements. The cylindrical structure 46 of the belt 4 may later be opened up to a troughed or a flat position in order to deposit the materials contained within the cylindrical structure 46.

The steep angle pipe conveyor system 2 may have a transporting section 8, a loading section 10 and a depositing section 12 (the depositing section 12 is not shown in FIG. 7A or 7B). A plurality of support elements 14 (e.g. idler panels) may support the belt 4 as it extends from a loading area to a depositing area, and may also support the belt 4 as it extends back to the loading area. The steep angle pipe conveyor system 2 may extend at an angle from thirty degrees to ninety degrees with respect to horizontal. In some embodiments, the steep angle pipe conveyor system 2 may also include segments that extend past ninety degrees with respect to horizontal. Each support element 14 may be closely spaced to another support element to provide support for the belt as it moves through the transporting section 8. In some embodiments, the supporting elements are spaced approximately 500 mm apart, although in other embodiments, the support elements are spaced more closely together or further apart. A first base structure 16 may support the loading section 10 of the steep angle pipe conveyor 2. A second base structure 20 may support the transporting section 8 of the steep angle pipe conveyor 2. The belt 4 may extend from a first end roller 24 (shown in FIG. 7A) to a second end roller 26 (shown in FIG. 8A). A motor 22 may drive one or both of the rollers 24, 26, which may in turn drive the belt 4. The belt 4 may deposit material into a receiving means 28 for further transport of the material. The depositing section 12 of the steep angle pipe conveyor may be supported by a third base structure 18. In some embodiments of the steep angle pipe conveyor 2, inclining means and/or a skirtboard may be provided.

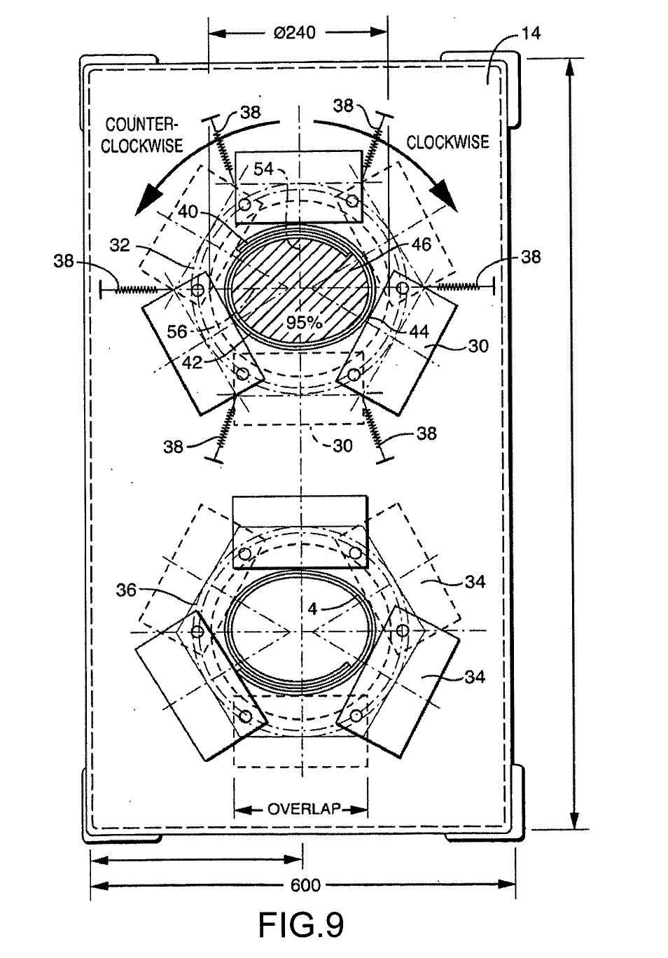

FIG. 9 shows a schematic side elevation view of one embodiment of a support element 14 to support the belt 4. Upper rollers 30 (e.g. idler rollers) may be positioned around a first opening 32 in the support element 14 and may be configured to guide the cylindrical structure 46 of the belt 4 through the first opening in the support element during transport. Lower rollers 34 (e.g. idler rollers) may be positioned around a second opening 36 in the support element 14 and may be configured to guide the cylindrical structure of the belt 4 through the second opening in the support element during return of the belt 4 to the loading section 10. The upper rollers 30 may be coupled to the support elements 14 via one or more biasing members 38 (e.g. a spring) in some embodiments, although in other embodiments the upper rollers may be coupled to support elements without biasing members. As mentioned above, the first belt section 40 may overlap the second belt section 42 to define a cylindrical structure 46, and the cylindrical structure 46 may have an oval-shaped cross section 44. The oval-shaped cross section 44 of the belt 4 may provide strength, stiffness and/or rigidity to the cylindrical structure 44. In some embodiments, the first belt section 40 overlaps the second belt section 42 by approximately ninety degrees in a circumferential direction, although the first belt section and second belt section may overlap less or more in other embodiments. The upper rollers 30 may be configured to contact the cylindrical structure 46 in order to help maintain the oval-shaped cross section 44 during transport, which may help prevent material from falling out of the steep angle pipe conveyor 2, or in some embodiments, may help prevent the belt 4 from turning clockwise or counter clockwise.

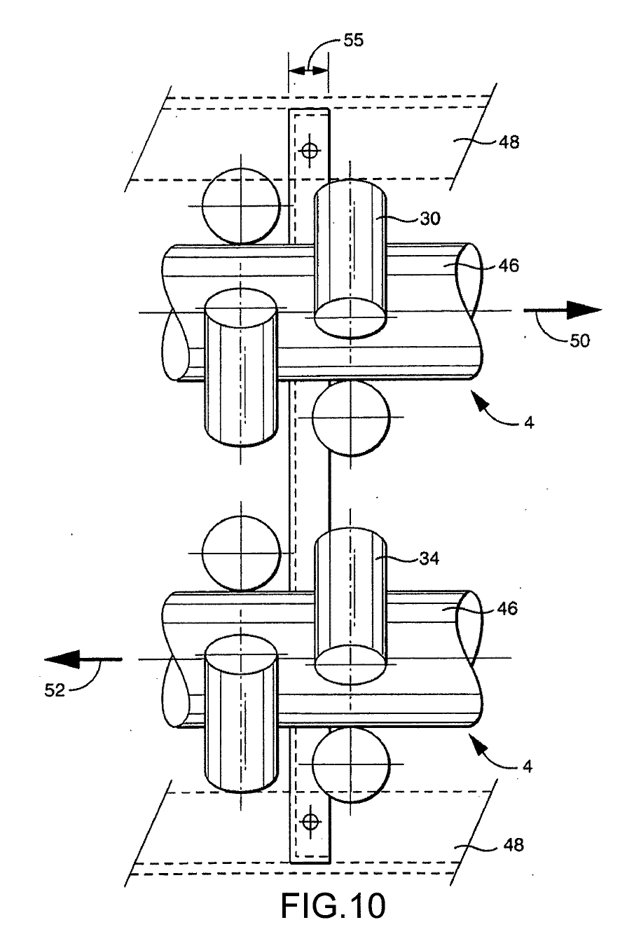

FIG. 10 shows a schematic side elevation view of one embodiment of a support element 14 that supports the belt 4. The support element 14 may be mounted to one or more framing members 48. FIG. 10 further shows the positions of upper rollers 30 and lower rollers 34 in relation to the belt 4, which may be in the form of cylindrical structure 46. The upper rollers 30 may guide the belt 4 in a transporting direction 50, while the lower rollers 34 may guide the belt 4 in a direction 52 opposite the transporting direction.

FIGS. 11A through 13B show several pipe conveyor features that may be implemented in a vertical pipe conveyor system (such as that shown in FIGS. 1 through 6), a steep angle pipe conveyor system (such as that shown in FIGS. 7A through 10), or many other types of pipe conveyor systems.

FIG. 11A shows a cross-section view of one embodiment of a belt 1101 that may be used in a pipe conveyor system, such as those described above. The belt 1101 may include reinforcement elements 1110 such as steel or polymer cords, woven carcass, longitudinal polymers, and so forth. In some embodiments, the reinforcement elements 1110 may be an order of magnitude stiffer than the belt 1101. The reinforcement elements may run longitudinally (e.g., parallel to the direction that the belt 1101 moves during transport) and/or run transversely to the belt 1101, or a combination of both. In some embodiments, the reinforcement elements 1110 may be located or embedded within the cross-section of the belt 1101, whereas in other embodiments, the reinforcement elements 1110 may be coupled to an outer surface of the belt 1101.

The reinforcement elements 1110 may be uniformly distributed in the belt 1101 in some cases, but in other cases, the reinforcement elements may be preferentially located within the belt 1101. For example, in one example of the implementation of this invention, FIG. 11A shows longitudinal reinforcement elements 1110 extending in a direction along the length of the belt and spaced in generally parallel relation to one another. Here, the reinforcement elements are located in a certain portion of the cross-section of the belt 1101—specifically in the lower portion of the belt. This lower portion is generally in the middle section 1102 of the belt as related to the width of the belt when extended in a flat configuration. Depending on the application, this middle section 1102 may be from a few inches wide to a few feet wide. A region on either side of the middle section (i.e. side portions 1103, 1104) may include fewer (including none) or smaller diameter reinforcement members, if any, to allow more flexible bending once in the pipe shape, as described below. In other words, a different region of the belt 1101 may have a lower density of reinforcement members than the middle section 1102 (e.g. fewer reinforcement members per cross-sectional linear section).

This middle section 1102 generally remains relatively un-curved in the cross section (note it may have some curve to it, as shown) when loaded and transporting material. The reinforcement elements 1110 strengthen this middle section 1102 of the belt 1101 in which they are positioned, and thus provide a sufficient carrying capacity for the material in the pipe conveyor. Because placing the reinforcement elements 1110 at the middle section 1102 of the belt 1101 has the effect of shifting the neutral axis of the belt 1101 toward the plane of the middle section 1102, these reinforcement elements remain relatively close to the neutral bending axis of the belt 1101 as the belt 1101 transitions through a curve in a vertical plane. This placement of the reinforcement elements 1110 may reduce the stress induced in the reinforcement elements 1110 as compared with the stress induced in any reinforcement elements located in the portions of the belt 1101 that must elongate more in traversing a bend (e.g., the side portions 1103, 1104 and/or overlapping edges 1105, 1106). Also the reinforcement elements 1110 located in the middle section 1102 of the belt 1101 may reinforce the belt 1101 sufficiently so that fewer and/or more flexible reinforcement elements may need to be used in the side portions 1103, 1104 and/or the overlapping edges 1105, 1106. As a result of the reduction in stress on the reinforcement elements in the middle section 1101 and the fewer or more flexible reinforcement elements in the side portions 1103, 1104 and/or the overlapping edges 1105, 1106, the belt 1101 formed into a pipe shape may be operated with relatively tight bend radii.

In this manner, the other portions of the belt 1101, such as the side portions 1103, 1104, may remain relatively flexible so that the belt may be more easily bent along the longitudinal dimension of the belt compared to if these side portions 1103, 1104 had reinforcement elements 1110 positioned therein. In other embodiments, transverse reinforcement elements (not shown) may be located in only a portion of the belt, such as in the lower portion 1102.

Longitudinal and/or transverse reinforcement elements 1110 may be used alone or together, and may be located in other portions of the belt 1101. Also, the reinforcement elements may be grouped together and located in a plurality of discrete portions of the width of the belt. For example the middle portion 1102 of the belt 1101 and the flap portions 1105, 1105 (e.g. those portions that overlap when the belt 1101 is formed into a cylindrical or oval pipe shape) of the belt 1101 may include longitudinal reinforcement elements, while the side portions 1103, 1105 do not. Again, the lack of, or reduced number or size of, reinforcement elements in the side portions facilitate easier bending of these regions when in the pipe formation.

FIG. 11B shows a cross-section view of another embodiment of a belt 1101 that may be used in a pipe conveyor system, such as those described above. The belt 1101 may include multiple types of reinforcement elements 1110, 1112. For example, the belt 1101 may include a first type of reinforcement elements 1110 that may be large, relatively more rigid, made of a strong material, relatively inflexible, and so forth. This first type of reinforcement element 1110 may be suited for use within a middle portion 1102 of the cross-section of the belt 1110, such as the portion of the belt 1101 that generally bends primarily in a plane generally orthogonal to the longitudinal extension of the belt, but generally does not bend in a plane generally parallel (or closer to parallel than orthogonal) to the extension of the belt, such as when the sidewalls are bent when changing elevation (see for example FIGS. 1, 7a, and 7b). The belt may also include a second type of reinforcement elements 1112 that may be smaller, more flexible, and so forth. This second type of reinforcement element 1112 may be suited for use within the side portions 1103, 1104 of the belt 1101. Generally, many different types of reinforcement elements may be used in various portions of the belt. As an example, inexpensive, bulky reinforcement elements may be used in one portion (e.g. middle portion 1102 that is unlikely to be significantly bent) of the belt 1101, whereas expensive, high-performance reinforcement elements may be used in other portions of the belt 1101 (e.g. side portions 1103, 1104 that will be subject to significant bending, stress, and so forth).

The reinforcement elements 1110, 1112 may be formed of a continuous length, or may be made of separate sections operably associated together to extending the desired length and orientations of the belt. It is contemplated that the reinforcement elements 1110, 1112 may be in generally the same plane when positioned in or on the belt 1101, or may be in different planes. There may be groups of reinforcement elements 1110, 1112 that are each positioned in different planes in relation to the belt 1101. Also, the reinforcement members 1110, 1112 may not run parallel to each other, or to the belt 1101, but may instead extend at a linear angle to one another or the belt 1101, or may form, along each element length, curves, angles, or a combination of both (in one or more planes) in the width and thickness of the belt 1101.

FIG. 12A shows a cross-section of one embodiment of a belt 1201 and a material plug 1215 that may be used in a pipe conveyor system, such as those described above. Generally, a plug 1215 shown in FIG. 12A, may be used in a pipe conveyor system in order to help limit, reduce or prevent material being transported on the belt 1201, when formed as an enclosed pipe conveyor, from moving rearwards along down the length of the belt 1201 during transport up an elevation gain. For example, in a mine with a vertical pipe conveyor system or a steep angle pipe conveyor system, material may be loaded onto the belt 1201 and then transported by the belt 1201 up an elevation gain to another location, such as an unloading station. If there is a temporary shortage of material to be loaded onto the belt, or if the mining production is finished for a work period, a material plug such as the material plug 1215 shown in FIG. 12A may be placed on the belt 1201 to help support the column of material in the formed pipe and to prevent the material from falling or moving back down the length of the belt 1201. The material plug 1215 may be positioned freely on the belt 1201 and/or secured to the belt 1201 behind the material to be held in place during transport. The plug 1215 may be positioned on the belt 1201 at or near the location where material is typically loaded onto the belt 1201. As the belt 1201 proceeds along the conveyor system and is formed into the pipe shape by overlapping two portions of the belt as noted above, the material plug 1215 may be held in position by circumferentially contacting at least some of the interior diameter of the pipe form. This may create a friction-fit to maintain the position of the plug 1215 along the length of the belt 1201, and form at least a partial seal around the plug 1215 to help restrict backflow of materials down the belt 1201. The material plug 1215 may in some embodiments not completely seal the cylindrical cross-section, but may prevent most of the material from falling back down the belt 1201. When the belt 1201 passes through an unloading or deposit station, the belt 1201 is converted from the pipe form to a more open form, at which point the material plug 1215 may be removed from the belt 1201.

The material plug 1215 may take several different forms. For example, the material plug 1215 may take one of many forms, such as a cylinder, oval, sphere, square cube or rectangular shape, so long as it compresses or is sized to be held in position by the surface of the belt when in the pipe configuration. The plug 1215 may be a hollow structure, inflatable, solid, or may be an outer bag-like construction filed with compressible material. The plug 1215 may be dimensioned to work with one or a limited range of sizes of pipe configurations, or may be suitable for use with a wide variety of sizes of pipe configurations. The plug 1215 may be made from various materials, such as rubber, plastic, cloth, wood, metal, or many combinations of the like. In other embodiments, the material plug 1215 may be a metal plate positioned to extend across the diameter (of internal dimensions) of the pipe configuration and secured in place by the radially-inwardly directed compressive forces of the belt 1201 when in the pipe configuration. The plug 1215 may also not be solid, such as a body made of screen or other shape with apertures formed therein, so long as such apertures do not allow a significant amount of material backflow along the belt 1201. Apertures in a plug 1215, or a discontinuous seal around the perimeter of a solid plug, may be beneficial to allow any liquids in the material column on the conveyor to flow through the plug 1215 and reduce the weight of the conveyed material. The retention friction and/or compression force applied by the belt 1201 to the plug 1215 to hold it in place may be designed to fail (i.e. when the load of the material overcomes a designated maximum allowable load and thus overcomes the friction and/or compressive retention forces on the plug 1201) at a certain load level to cause the plug 1201 to slip backwards along the belt 1201 and help protect the belt 1201 from reaching a load level that would cause failure.

FIG. 12B shows a cross-section of another embodiment of a belt 1201 and material plugs 1216A, 1216B that may be used in a pipe conveyor system, such as those described above. The material plugs 1216A, 1216B shown in FIG. 12B may be similar to the material plug 1215 shown in FIG. 12A, except that there are two material plugs 1216A, 1216B in FIG. 12B. In general, many different number of material plugs may be used, and in many different combinations of freely positionable and/or selectively securable.

It is contemplated that a plug 1215, 1216 may be positioned in front of a section of material on a belt 1201 in the event the material travels along a path that decreases in elevation. The plug 1215, 1216 would then prevent the material from moving ahead on the belt 1201 if that is not desired. The plug 1215, 1216 may be positioned as described above. A plug 1215, 1216 may be positioned at either end of a length of material to be transported if the conveyor system travels over a system that both gains and loses elevation along portions of the conveyor path.

FIG. 12C shows a cross-section of another embodiment of a belt 1201 and a material plug 1218. As noted above, the plug 1218 may be freely positioned on the belt 1201, and held at the desired position by frictional and/or compressive forces applied to the plug 1218 by the belt 1201 when in the pipe configuration. It is also contemplated that the plug 1218 may be mounted in a fixed position to provide a positive engagement of the plug 1218 in a particular position along the length of the belt 1201. The mounting may be, in one example, a mechanical attachment structure. For instance, the belt 1201 may have a metal loop 1220 secured to the belt 1201 (such as in the middle portion of the belt, which may comprise longitudinal reinforcement elements) and extending from its surface. The plug 1218 may have a selectively securable hook 1226 attached to the plug 1218 and extending from the plug 1218 to engage the loop 1220 and thereby mechanically secure the plug 1218 in a particular position along the belt 1201. The mounting structure 1220, 1226 may be the primary or only cause of the plug 1218 staying in its desired location, or it may be combined with the compressive and or frictional retention force noted above. The mounting structure may be positioned at one location along the belt 1201, or may be positioned at regular or irregular intervals along the belt 1201. The mounting structure 1220, 1226 may also be designed to fail at a particular load level, such as by the selectively securable hook 1226 having a spring mechanism that opens at a certain load level, or a material/structural design that fails at a predictable load level to release the plug 1218 from its secured position. Other mounting structures may also be used to secure the material plug 1218 to the belt 1201, including but not limited to a ball and socket, a carabiner and loop, metal spikes, and so forth.

While specific embodiments of the invention have been shown and described in detail to illustrate the application of the principles of the invention, it will be understood that the invention may be embodied otherwise without departing from such principles. For example, although the friction drive conveyors and friction tires in FIGS. 1 through 6 have been described and shown as used within the inclined section of the pipe conveyor, friction drive conveyors and/or friction tires may also be used in the horizontal sections of the pipe conveyor. Further, while FIGS. 1 and 5 show the pipe conveyor as having one inclined section and two horizontal sections, the system described above could be used with pipe conveyor systems that have multiple inclined and horizontal sections.

All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other. Reference to “a” or “one” is not intended to limit the description to one only, but may be interpreted as including “one or more than one” unless otherwise specifically indicated by description or context of the related structure or function.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A conveyor system, comprising:
a pipe conveyor including a head end, a tail end positioned at an elevation lower than the head end, and an inclined section between the head end and the tail end; and
a conveyor belt comprising a first portion and a second portion, the first portion comprising a first type of longitudinal reinforcement elements and the second portion not having any of the first type of longitudinal reinforcement elements.

2. The conveyor system of claim 1, wherein the first portion is adjacent the second portion in a cross-section of the conveyor belt.

3. The conveyor system of claim 1, wherein the longitudinal reinforcement elements comprise steel cords.

4. The conveyor system of claim 3, wherein the steel cords are an order of magnitude stronger than the conveyor belt.

5. The conveyor system of claim 1, wherein the longitudinal reinforcement elements comprise polymer cords.

6. The conveyor system of claim 1, wherein the second portion of the conveyor belt comprises a second type of longitudinal reinforcement elements.

7. The conveyor system of claim 6, wherein the second type of longitudinal reinforcement elements are more flexible than the first type of longitudinal reinforcement elements.

8. The conveyor system of claim 6, wherein the second portion of the conveyor belt is bent when the conveyor belt is formed into a pipe shape, and the first portion remains substantially flat when the conveyor belt is formed into the pipe shape.

9. The conveyor system of claim 1, wherein the first portion of the conveyor belt comprises transverse reinforcement elements.

10. A conveyor system, comprising:
a pipe conveyor including a head end, a tail end positioned at an elevation lower than the head end, and an inclined section between the head end and the tail end;
a conveyor belt comprising a first portion and a second portion, the conveyor belt configured to form a pipe shape when the first and second portions of the conveyor belt are overlapped; and
a material plug configured to circumferentially engage at least a portion of an internal surface of the conveyor belt when the conveyor belt is formed in the pipe shape and help prevent backflow of a material transported in the pipe shape of the conveyor belt.

11. The conveyor system of claim 10, wherein the material plug is selectively secured to the conveyor belt.

12. The conveyor system of claim 11, wherein the material plug comprises a hook and the conveyor belt comprises a loop, and the hook is selectively secured to the loop.

13. The conveyor system of claim 10, wherein the material plug is spherical.

14. The conveyor system of claim 13, wherein the material plug comprises rubber.

15. The conveyor system of claim 13, wherein the material plug is inflatable.

16. The conveyor system of claim 10, wherein the material plug is configured to partially seal a cross-section of the pipe shape of the conveyor belt.

17. A conveyor belt, comprising:
a middle portion, a first side portion coupled to the middle portion, and a second side portion also coupled to the middle portion, the middle portion comprising a first type of longitudinal reinforcement elements extending along a length of the conveyor belt, and the first and second side portions being more flexible than the middle portion; and
a first flap coupled to the first side portion and a second flap coupled to the second side portion, the first and second flaps configured to overlap when the conveyor belt is formed into a pipe shape to transport a column of material.

18. The conveyor belt of claim 17, wherein the first and second side portions do not have any of the first type of longitudinal reinforcement elements.

19. The conveyor belt of claim 17, wherein the first and second side portions comprise the first type of longitudinal reinforcement elements, and wherein a density of the first type of longitudinal reinforcement elements in the middle portion is greater than a density of the first type of longitudinal reinforcement elements in the first or second side portion.

20. The conveyor belt of claim 18, wherein the first and second side portions comprise a second type of longitudinal reinforcement elements, the first type of longitudinal reinforcement elements being stiffer than the second type of longitudinal reinforcement elements.

21. The conveyor belt of claim 18 wherein the first and second flaps do not have any of the first type of longitudinal reinforcement elements.

22. The conveyor belt of claim 17, further comprising:
a removable plug selectively coupled to the middle portion, the removable plug configured to prevent backflow of the column of material when the conveyor belt is formed into the pipe shape.
